(19) United States
(12) Patent Application Publication
(10) Pub. No.: US 2013/0293475 A1
(43) Pub. Date: Nov. 7, 2013

(54) TYPING EFFICIENCY ENHANCEMENT SYSTEM AND METHOD

(71) Applicants: Uriel Roy BRISON, Tel Aviv (IL); Dov MORAN, Kfar Saba (IL)

(72) Inventors: Uriel Roy BRISON, Tel Aviv (IL); Dov MORAN, Kfar Saba (IL)

(21) Appl. No.: 13/461,792

(22) Filed: May 2, 2012

(51) Int. Cl. G06F 3/02

(52) U.S. Cl. 345/168

(57) ABSTRACT

A method for a user operating a computer device that includes a computer program, a keyboard, a screen display and driver software. The method includes the driver software receiving information from the keyboard by indicating where the user's fingers are located and associating the information with keyboard keys by the driver software upon receiving the information and generating an image on the screen. The method further includes determining where to display the image on the screen, transmitting the generated image to be displayed on the screen and indicating by the image of a depiction of an on-screen keyboard key display to the user the location of his fingers and which key he is likely to hit next, and where his hands are oriented with respect to the keyboard, such that the device assists in creating a closed eye-brain feedback loop, allowing a user to type without pause.

### FIELD OF THE INVENTION

The present invention relates to keyboard input devices in general, and to a more convenient device and method for providing input to computerized devices in particular.

### BACKGROUND OF THE INVENTION

Interactions with computerized devices are generally achieved through the use of input devices. Input devices associated with computerized devices commonly include keyboards used for providing the computer signals interpreted as characters. Most users of such regular keyboards, must repeatedly lift up their heads; re-focus the eyes on the computer screen and search for the current cursor position in order to see the text that has just been typed. Re-focusing of the user's field of view (FoV) is performed very often during typing, sometimes as often as every few seconds. The speed and accuracy of typing, for most users, is reduced considerably, because they have to refocus their FoV from the screen to the keyboard and vice-versa.

Even with the rise in popularity of computer use, and though most people spend a large proportion of their time, at home or at work, using keyboards, very few people are full “touch typists.” That is, they are incapable of keeping their FoV focused on the screen, while continuously using a keyboard for character input. Users of keyboards and like input devices can type for a period of time without looking at the keyboard, but must stop once in a while to re-orient their hands over the keyboard or look for a specific key on the keyboard, while shifting their eye focus. This shift in eye focus usually occurs once every few seconds in most users.

Reference is now made to prior art FIG. 1, which shows a side view of a computerized environment. FIG. 1 illustrates a typical computerized device, typically comprising a keyboard 102 connected to computer (not shown). Said computer is connected to a display screen 104. When keys are pressed on keyboard 102, a corresponding at least one character is displayed on display screen 104. Keyboard 102 is located in Field of View1 (FoV1) outside the FoV2, in which display screen 104 is located. A user 106 would typically shift gaze and refocus between keyboard 102 and screen 104. The keyboard distance 105 from the user's eyes to keyboard 102 and the screen distance 103 from the user's eyes to screen 104 is different, therefore requiring a change of eye focus when shifting from FoV1 to FoV2 and vice versa.

Prior art FIG. 2 shows a front view of the Fields of View shown in FIG. 1, that a user has for typical prior art devices. FIG. 2 further shows the eye-to-keyboard FoV 202 and eye-to-screen FoV 204 of FIG. 1 are depicted as circle shaped. A user of the computerized device of FIG. 2 looking at screen 206 will generally have FoV 202 and focal point 208. During typing the typical user will shift FoV from FoV 202 to FoV 204 and focus on focal point 210. The distance from the user's eyes (not shown) to focal point 208 and focal point 210 is not equal, requiring a change of focus for every shift between FoV 202 and FoV 204. It will be clear from FIGS. 1 and 2 that the non-overlapping FoVs are constantly switched back-and-forth when typing, requiring focus reorientation pauses between typing.

There is therefore a need for a device and method to allow users of computerized devices such as keyboards to do away with some or most focus re-orientation pauses.

### SUMMARY OF THE INVENTION

Accordingly, it is a principal object of the present invention to increase typing speed, improve accuracy, and prevent deterioration of eyesight while performing input to computers and other electronic keyboard-enabled devices.

It is another principal object of the present invention to provide computer systems that overcome the drawbacks of separating the input device, e.g. a keyboard, from the display of the data entered.

It is one other principal object of the present invention to provide an input device and method for use with computerized devices that reduce the need to shift FoV from an output device to an input device.

It is a further principal object of the present invention to increase the speed and accuracy of using an input device, such as a keyboard in connection with a computerized device having an output device, such as a screen display, showing the input made.

It is one further principal object of the present invention to provide a user of the computerized device an indication preferably on an output device, such as a screen display, as to the location of the user's fingers.

It is yet another principal object of the present invention to determine the location of the user's fingers and/or to determine which keys the user is likely to use next, based on various indications received from the input device, and to display on an output device, such as a screen display, the user's fingers location as well as a depiction of the input device under said fingers.

It is still another principal object of the present invention to determine the characters that will be generated by typing on the keyboard keys in the vicinity of the fingers of the user and displaying on the output device, such as the screen display, a display, such as keyboard keys, showing the characters that will be entered should either of the keys be engaged.

It is yet still another principal object of the present invention to reduce the need for the user of a computerized device to shift a field of view or refocus his eyesight between an input device such as a keyboard and an output device such as a screen.

It is one more principal object of the present invention to achieve a new type of keyboard with an enhanced level of typing efficiency and user friendliness.

A method is disclosed for a user operating a computer device that includes a computer program, a keyboard, a screen display and driver software. The method includes the driver software receiving information from the keyboard by indicating where the user's fingers are located and associating the information with keyboard keys by the driver software upon receiving the information and generating an image depicting an on-screen keyboard key display on the screen. The method further includes determining where to display the generated image on the screen, transmitting the generated image for display on the screen and indicating to the user by the generated image the location of his fingers, which key he is likely to hit next and where his hands are oriented with respect to the keyboard, such that the device assists in creating a closed eye-brain feedback loop, allowing a user to type without pause.

Aspects of the present invention relate to various embodiments of keyboards and displays, including inter alia (i) computer systems wherein a representation of the keyboard and the location the user's hands or pointing devices on the keyboard are displayed, (ii) keyboards having touch sensors for determining multiple points of contact thereon by a user, (iii) computer systems wherein variation in the physical keystroke on a given key activates correspondingly different functions and wherein a menu of these different functions is presented on the display screen when a user approaches or touches the given key, (iv) computer systems for handicapped individuals that enable user input without requiring the user to look at the input device.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure.

In the drawings:

FIG. 1 shows a side view of a prior art computerized environment in which the invention may be used;

FIG. 2 shows a front view of a prior art computerized environment in which the invention may be used;

FIG. 3 shows an input device and an output device, constructed in accordance with some exemplary embodiments of the present invention;

FIG. 4A shows the on-screen display of keys, constructed in accordance with some embodiments of the present invention;

FIG. 4B shows an output device and options for display, constructed in accordance with some exemplary embodiments of the present invention; and

FIG. 5 shows a side-view of an input device, constructed in accordance with some embodiments of the present invention.

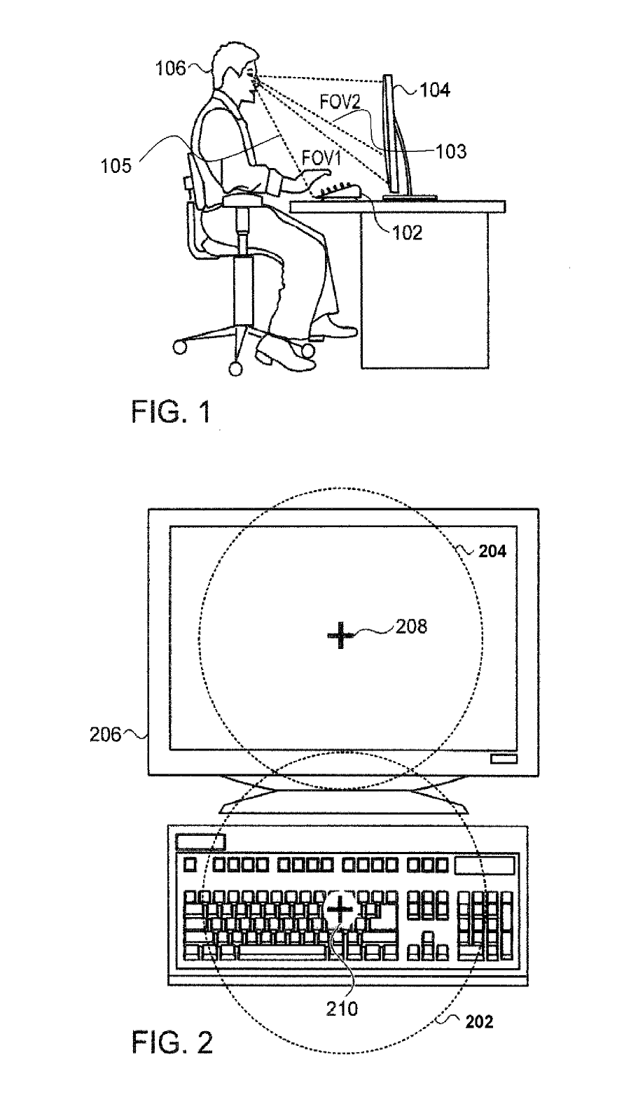

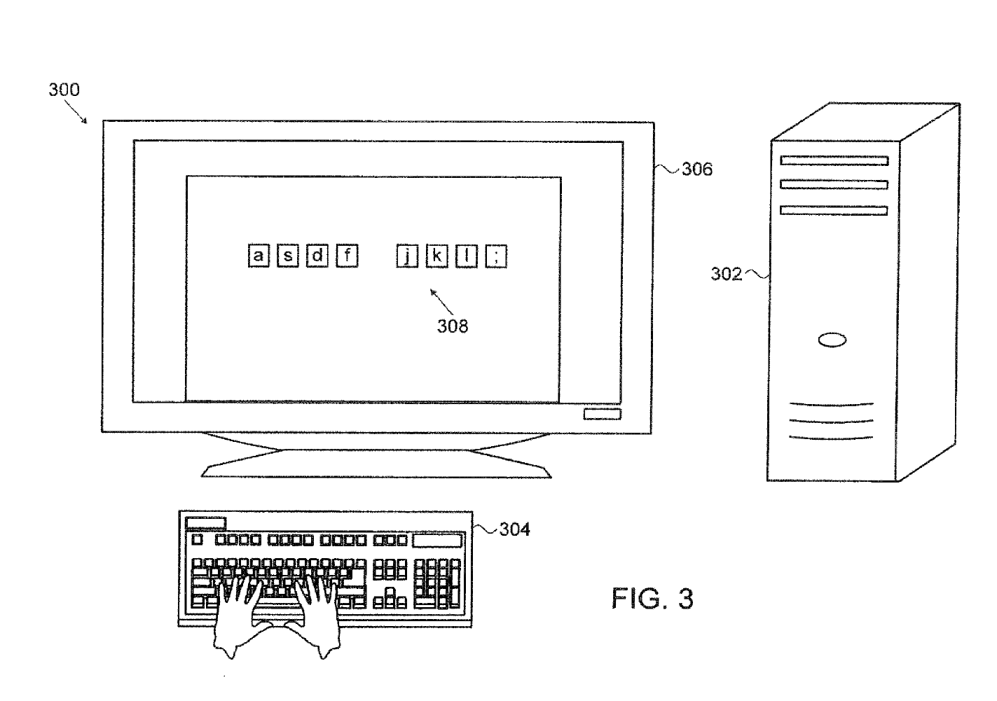

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

FIG. 3 shows input and output devices, constructed in accordance with some exemplary embodiments of the present invention. FIG. 3 shows a computer environment 300, which provides a computer 302 (or other computerized device), an input device, such as a keyboard 304 and an output device, such as a screen display 306. Computer 302, keyboard 304 and screen display 306 are interconnected through wireless or wired connections (not shown). Computer 302 or keyboard 304 may include a set of instructions typically implemented by computer program instructions.

These computer program instructions may be provided to a processor of a general purpose computer, special purpose computer or other programmable data processing apparatus incorporated into a system, such that the executed instructions create means or devices for implementing the functions/acts specified in the drawings and/or their descriptions.

The computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process, such that the instructions which execute on the computer or other programmable apparatus provide processes for implementing the functions/acts specified in the flowchart and/or block diagram block or blocks.

In accordance with some embodiments of the subject matter, when a user places his hands on keyboard 304 an image 308 is displayed on screen display 306 in the vicinity of the character entry point. Such location can, in some embodiments of the present invention, be in the vicinity of an indicating element such as a cursor, mouse cursor, text entry cursor, highlighted location, field entry and the like. Image 308 can be a graphical or animated layover or any graphical or other depiction of the location of the user's fingers with respect to the input device. In some embodiments image 308 can be replaced by auditory indication, such as for example for the hard of hearing.

In other embodiments of the subject matter, image 308 can be replaced by vibratory indication. Image 308 indicates to the user the location of his hands or fingers on the keyboard, and may also indicate what keys the user is touching or about to touch. In some other embodiments, image 308 can provide a further indication as to which keys the user is likely to touch based on various indicators collected by computer device 302.

In view of image 308, the user of computer 302 can then type freely without having to pause and look at the keyboard in order to re-orient his hands or in order to find a certain key to press next. The keys the user's hands are touching, and in some cases adjacent keys, are made visible to him on the screen through image 308 as he is typing.

In accordance with a preferred embodiment of the invention, computer 302 comprises a computer program, such as driver software (not shown) that receives information from keyboard 304, indicating where the user's fingers are located, or the vicinity thereof.

Upon receiving such information, the driver software associates the information with one or more keyboard keys and generates image 308. Next, the driver determines where to display image 308 on the screen display 306. Next, driver software transmits the generated image 308 to be displayed on the screen display 306. The image 308, which is a depiction of an on-screen keyboard keys display, indicates to the user the location of his fingers and/or hand and which key he is likely to hit next, and where his hands are oriented with respect to the keyboard. The driver software may also determine which character will be displayed on the screen given depression of any key and generate a display an image 308 wherein the characters on the image correspond to those which will be generated by computer 302 when the user activates the keys.

In accordance with some embodiments of the present invention, the device assists in creating a closed eye-brain feedback loop, allowing a user to type without pause to look at the keyboard.

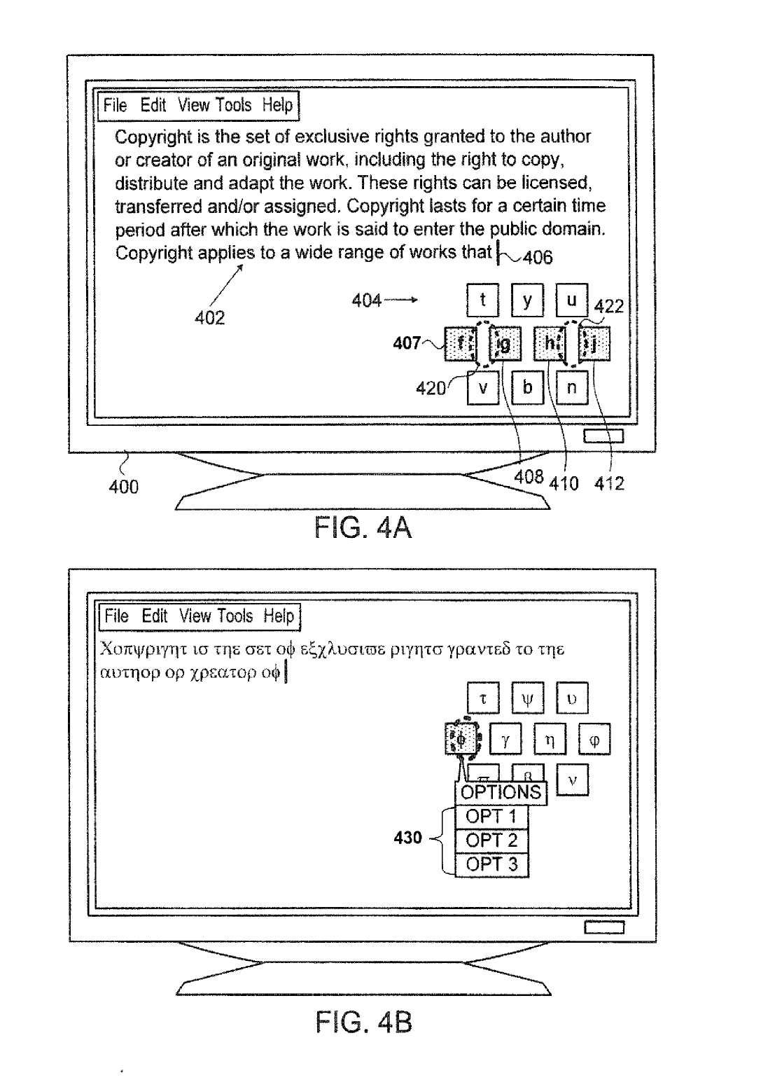

FIGS. 4A and 4B show the on-screen display of keys, constructed in accordance with some embodiments of the subject matter. Screen display 400 depicts a user screen, wherein a word processing program such as Word by Microsoft Inc., Redmond, Wash. has been implemented. The user (not shown) is entering text 402. The driver software receives information from the keyboard and, as described above, generates an image 404 that is displayed in the vicinity of the cursor 406. Image 404 may take different shapes and forms, and can be configurable by the user. Image 404 is an exemplary image, showing an on screen display design. In accordance with this exemplary image design, a segment of a keyboard image is shown, such that each key is separately depicted. The touched keys 407, 408, 410 and 412 are highlighted.

In some exemplary embodiments, an indication of the user's fingers touching the touched keys may be shown. Indication 420 illustrates that the user is touching keys 406 and 408 with one finger. Indication 422 indicates that the user is touching keys 410 and 412 with another finger. In some exemplary embodiments, a key may have several meanings 430, as is exemplified in FIG. 4B. For example, in some languages, such as Chinese, a key may be used to indicate several characters. In some exemplary embodiments, a gesture or method of interacting with the keyboard may be utilized to indicate a different meaning to the same key, such as for example pressing softly, tapping, sliding a finger on the key and the like.

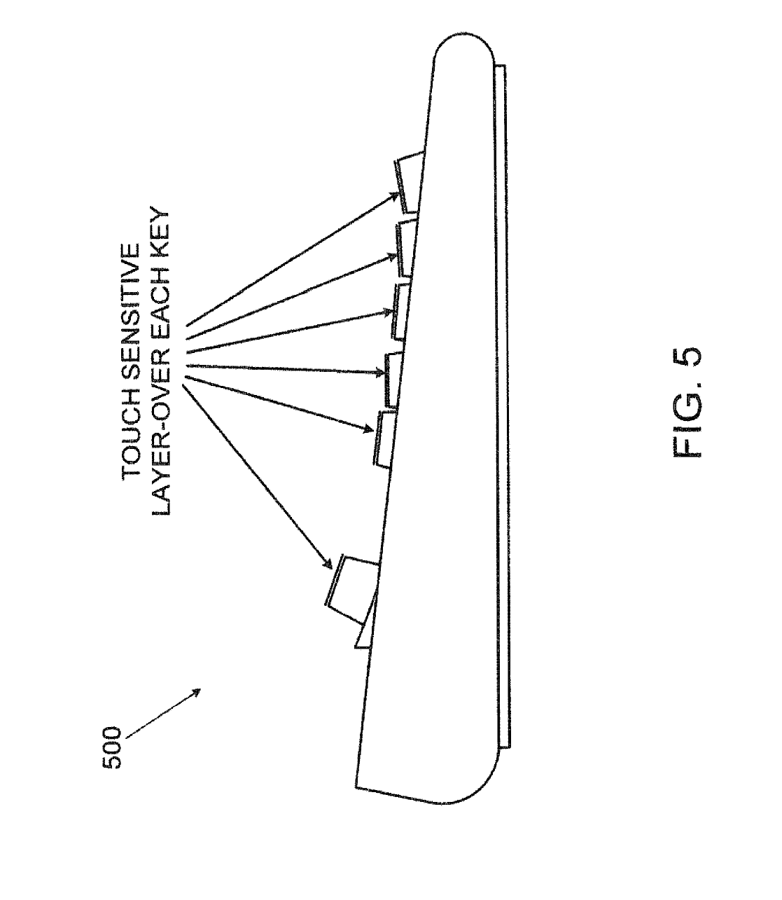

FIG. 5 is a side-view illustration of an input device, constructed in accordance with some embodiments of the present invention. Exemplary keyboard 500 is comprised of capacitive or resistive layers positioned over the keys, or over the entire keyboard. Such capacitive or sensitive layers are connected to a processing unit (not shown), which in some embodiments can be the keyboard-processing unit. When a user finger is in contact with the layer, an electrical charge is sent, or a capacitive value is changed, providing the processing unit an indication that the user's finger is close, or in contact with, the key. The processing unit generates and sends a signal to the driver software of FIG. 3.

In other embodiments of the present invention, ultrasound sensors and/or light sensitive sensors and/or infrared sensors positioned in various locations on the keyboard and/or a camera located on or in the vicinity of the keyboard can be used to identify the vicinity of the user's fingers to the keys or if said fingers are in contact with the keyboard.

In another embodiment of the present invention touch sensitive sensors are placed over the keys (or the keyboard). In accordance with such an embodiment, the processing unit determines the position of the user's hand when the user is in contact with any one or more of the keyboard keys. The driver software will generate an image that will show the current location of the fingers as long as they are placed over keyboard keys.

In yet another embodiment of the present invention the driver software generates and displays an image of a finger placed over more than one key, such as when the finger is located between two keys. By employing other types of sensors, such as a camera sensor, ultrasound sensors (or other types) the continuous position, and optionally the distance from the keyboard keys of the user's fingers can be determined.

In accordance with the principles of the present invention the user is provided with a real-time or near real-time indication of his hands and/or fingers current position throughout the typing process. The current position of the user's hands/fingers includes a three dimensional representation of the keyboard and hands/fingers to allow better accuracy and improve the typing process, and/or correct any pre-existing positions the user may be using which may lead to inefficiency, errors in typing, pain in the hand muscles and the like.

Instead of, or in addition to, the on-screen display, an audio indication of the position of the users hands can be provided in some embodiments of the present invention. Different tones, rhythms, levels of volume or other sound variations can be used to indicate to the user the position of his hands over the keyboard input device. In some other embodiments of the present invention, gesture motions and/or hand movements of various types can be employed in association with touch sensitive sensors, camera sensors or other sensor types. The user will be able to perform gesture motions on or above the keyboard in order to achieve a specified function, such as opening an application, inputting a preset text string or any other preset function. In yet other embodiments of the present invention, the user may be shown a pull down menu and may make a selection directly from a pre-assigned key in the vicinity of the location of his fingers, or use another input device such as a pointing device.

In other embodiments of the present invention, in an input device that utilizes touch sensitive sensors, the different levels of pressure applied by the user during typing can be measured and accordingly different functions can be activated as a result of the amount of pressure applied. One exemplary embodiment would include an analysis of the touch sensitive sensors. If the duration or amount of pressure applied to the touch sensitive sensors is greater than a predetermined threshold, an appropriate indication is provided, and in the present example a capital letter or an alternate character is provided as an output. Other examples can include outputting a lower case character with weaker pressure applied, providing secondary function to any key upon a predetermined pressure applied, such as pull down menu if the key was pressed more than a predetermined amount of milliseconds.

Persons skilled in the art will appreciate that the present invention can be implemented in various devices, including Personal Computers, Laptop computers, Television sets with keyboard input devices, mobile telephones, mobile data devices and the like. The definition of input device and/or “keyboard” is not limited to any specific input device, computer or other keyboard and particular layout or any number of keys, or keys functions. The present invention can be applied to various text or character input devices in various layouts and configurations. The on-screen display can be shown on different devices such as screens, television sets, mobile device screens, projectors, display glasses, head mounted displays, on one or more displays, in various shapes sizes and configurations.

The present invention can also be adapted for blind, but not hard of hearing typists. It can also work for people who cannot use their hands and need to type using their feet or artificial pointing devices.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

1. A system for typing efficiency enhancement associated with a computerized device comprising a keyboard and a display, said system comprising:
at least one sensing device associated with said keyboard for determining the presence of the user's fingers and for providing an indication to the computerized device of the presence of the user's fingers in the vicinity thereof;
a computer program for receiving and processing said indication from the keyboard and in response thereto providing the computerized device with an image to be displayed on the display device,
whereby the image represents the proximate location of the fingers of the user relevant to the keyboard.

2. A method for typing efficiency enhancement associated with a computerized device comprising a keyboard and a display, the keyboard comprising at least one sensing device, the method comprising:
determining the presence of the user's fingers in the vicinity of the keyboard;
providing an indication to the computerized device of the presence of the user's fingers in the vicinity of the keyboard;
processing said indication from the keyboard,
and in response thereto,
providing the computerized device with an image to be displayed on the display device,
whereby the image represents the proximate location of the fingers of the user relevant to the keyboard.

3. The method of claim 2, wherein the device assists in creating a closed eye-brain feedback loop allowing a user to type without pause to look at the keyboard.

4. The method of claim 2, further comprising determining by the driver software which character will be displayed on the screen given at least one key has been typed, and generating a display image of characters corresponding to the at least one typed key, wherein said image is generated by the computer device when the user types said keys.

5. The method of claim 2, further comprising receiving by the user of visual indication of the motions of his hands or fingers as he is inputting text in form of visual graphics on a connected display screen.

6. The method of claim 2, further comprising receiving information from the keyboard by the driver software indicating where the user's fingers are located, or the vicinity thereof.

7. The method of claim 2, further comprising associating the information with one or more keyboard keys by the driver software upon receiving the information and generating an image on the screen display.

8. The method of claim 2, further comprising determining where to display the generated image on the screen.

9. The method of claim 2, further comprising transmitting the generated image for display on the screen and indicating to the user by the generated image the location of his fingers, which key he is likely to hit next and where his hands are oriented with respect to the keyboard, such that the device assists in creating a closed eye-brain feedback loop, allowing a user to type without pause.

10. A keyboard comprising a sensor apparatus that facilitates an on-screen image indication of the location of the users' fingers or hands over the keyboard, wherein the on-screen image indicates the location of fingers or hands in a graphical shape, and wherein the on-screen image is projected on a screen display.

11. The keyboard of claim 10, wherein the sensors are at least of ultrasound sensors, light sensitive sensors, infrared sensors, video sensors and capacitative sensors positioned in various locations on the keyboard

12. The keyboard of claim 10, wherein a camera is located on or in the vicinity of the keyboard to identify the vicinity of the user's fingers to the keys or to determine whether his fingers are in contact with the keyboard.

13. A computer device which received location information from a text input device comprising at least a keyboard, and displays data on a screen indicating to the user the location of his hands or fingers during text entry.

14. The computerized device of claim 13, wherein said device displays additional information regarding keys which are adjacent to the keys the user is using or touching, wherein said keys are keys the user clicks on as the typing session continues.

15. The computerized device of claim 13, wherein said device displays a map of keys on the screen in a way that aids the user's typing session by providing him information regarding the availability of inputting additional characters as a result of pressing keys in relation to the keys his hands or fingers are touching.
